(19) United States
(12) Patent Application Publication
(10) Pub. No.: US 2017/0060519 A1
(43) Pub. Date: Mar. 2, 2017

(54) METHOD OF IDENTIFYING MEDIA TO BE PLAYED

(71) Applicant: UBITHINGS SAS, Paris (FR)

(72) Inventors: Olivier Roberdet, Paris (FR); Pierre Gochgarian, Paris (FR); Arthur Eberhardt, Paris (FR); Pierre Verdu, Paris (FR)

(21) Appl. No.: 14/840,177

(22) Filed: Aug. 31, 2015

(51) Int. Cl. G06F 3/16; H04R 29/00

(52) U.S. Cl. CPC G06F 3/165; H04R 29/004

(57) ABSTRACT

A method for identifying media to be played in a playback environment is disclosed. The method comprises determining context information relating to the playback environment; identifying an electronic device present in the playback environment, the electronic device corresponding to a user; determining preference information associated with the user; and identifying media to be played in the playback environment based on the context information and the preference information.

### FIELD

This disclosure relates to a method of identifying media to be played in a playback environment, and in particular, but without limitation, to a method of playing back media based on context information relating to the playback environment.

### BACKGROUND

Creating playlists of songs can be a somewhat arduous task. Some users may use software to randomly generate a playlist based on the content of their media library, or based on the content of an online music repository (such as Spotify® or Deezer®). However, this playlist will often need some manual tweaking, or the user will have to skip songs they do not want to listen to as and when they are played. Other users may manually select songs to form part of their playlist, although this can be extremely time-consuming.

The music which users wish to listen often changes over time. For example, when a user wakes up in the morning, they may wish to listen to energetic music, while in the evening they may prefer to listen to more relaxing music. This leads to many users creating separate playlists for use at different times. There may also be long-term changes in the music a user wishes to listen to, as their musical tastes evolve. As a consequence, the user needs to constantly update their playlists or create new playlists so that they are able to listen to music they want to listen to at that instant in time. This takes up even more of the user's time as well as increasing the storage needs of the user.

### SUMMARY

In accordance with an aspect of the present disclosure, there is provided a method for identifying media to be played in a playback environment. The method comprises determining context information relating to the playback environment; identifying a user present in the playback environment; determining preference information associated with the user; and identifying media to be played in the playback environment based on the context information and the preference information.

The playback environment may comprise a single room, or an entire home/building. The playback environment could be a certain outside space.

Determining the context information may comprise receiving the context information from a sensor operable to sense a characteristic of the playback environment.

Determining the context information may comprise receiving the context information from a sensor operable to sense one of a number of people present in the playback environment, a temperature in the playback environment, a movement in the playback environment, a sound level in the playback environment, and a light level in the playback environment.

Determining the context information may comprise determining at least one of a current date, a current time, and a current weather condition. The context information may comprise additional data from a provider such as a web service of another connected device.

The method may further comprise determining context information relating to the user. Identifying media to be played in the playback environment may comprise identifying media to be played in the playback environment based on the context information relating to the playback environment, the context information relating to the user, and the preference information.

The method may further comprise determining context information relating to the user based on biometric data, and wherein identifying media to be played in the playback environment comprises identifying media to be played in the playback environment based on the context information relating to the playback environment, the context information relating to the user, and the preference information.

Identifying a user in the playback environment may comprise detecting radiofrequency signals emitted by an electronic device associated with the user and identifying the user based on the radiofrequency signals.

Identifying a user in the playback environment may comprise detecting radiofrequency signals emitted by an electronic device associated with the user, determining that the electronic device is present in the playback environment based on a strength of the radiofrequency signals, and identifying the user based on the radiofrequency signals.

Identifying a user in the playback environment may comprise detecting biometric data associated with the user. The biometric data may be voice data for voice-based identification of the user.

Determining preference information associated with the user may comprise obtaining preference information from a profile associated with the user.

The method may further comprise receiving feedback indicative of the user's preference regarding the media; and updating the preference information based on the feedback.

The method may further comprise receiving feedback indicative of the user's preference regarding the media; and updating a profile associated with the user based on the feedback.

Receiving feedback indicative of the user's preference regarding the media may comprise receiving at least one of a skip command, a like command, and a dislike command. The user playing the media in its entirety may be used as feedback indicative of the user liking the media.

Identifying media to be played in the playback environment based on the context information and the preference information may comprise determining seed data associated with the media to be played by combining the context information and the preference information; and receiving the media to be played based on the seed data.

The method may further comprise receiving the media to be played from a repository.

The method may further comprise receiving the media to be played from a repository; receiving feedback indicative of the user's preference regarding the media; and sending the feedback to the repository.

The user present in the playback environment may be a first user, and identifying a user in the playback environment may comprise identifying the first user and identifying a second user present in the playback environment, and determining preference information may comprise combining preference information associated with the first and second users.

In accordance with another aspect of the present disclosure, there is provided a method for selecting an audio track to be played in a listening environment. The method may comprise determining context information relating to the listening environment, wherein determining context information relating to the listening environment comprises detecting a listener present in the listening environment; determining preference information for the listener; and generating an identifier based on the context information and the preference information, the identifier identifying an audio track to be played in the listening environment. The selected audio track may be one track of a large audio catalogue. The generating of the identifier may comprise selecting the identifier. The selected identifier may be the most relevant identifier.

The method may further comprise receiving feedback regarding the audio track and updating the preference information based on the feedback.

In accordance with another aspect of the present disclosure, there is provided an apparatus suitable for playing media in a playback environment. The apparatus may comprise a processor configured to carry out a method as described herein. More specifically, the processor may be configured to determine context information relating to the playback environment; identify a user in the playback environment; determine preference information associated with the user; and identify media to be played in the playback environment based on the context information and the preference information.

The apparatus may further comprise a sensor operable to sense a characteristic of the playback environment, and determining the context information may comprise receiving the context information from the sensor.

The apparatus may further comprise one or more sensors, wherein each of the one or more sensors is one of a communications interface operable to sense a number of people present in the playback environment; a motion sensor operable to sense a movement in the playback environment; a temperature sensor operable to sense a temperature in the playback environment; a microphone operable to sense a sound level in the playback environment; and a photodetector operable to sense a light level in the playback environment. Determining the context information may comprise receiving the context information from the one or more sensors. Determining the context information may comprise receiving data from the one or more sensors and determining context information from the received data. The context information may be determined from the received data using a machine learning algorithm.

The apparatus may further comprise a user interface, and the controller may be further configured to receive feedback indicative of the user's preference regarding the media via the user interface.

The apparatus may further comprise a communications interface and an output interface, and the controller may be further configured to receive the media via the communications interface and play the media via the output interface.

In accordance with another aspect of the present disclosure, there is provided a non-transitory computer-readable medium carrying computer-readable instructions arranged, upon execution by a processor, to cause the processor to carry out a method as described herein.

The present disclosure provides a method of intelligently selecting music tracks to be played in a room based on context and the people in the room. This allows a device implementing the method to instantly play music that the people in the room are likely to enjoy at a particular time, with very little effort required on their part.

### BRIEF DESCRIPTION OF THE DRAWINGS

Examples of the present disclosure will now be explained with reference to the accompanying drawings in which:

FIG. 1 shows a diagram of a playback environment where the methods described herein can be used;

FIG. 2 shows a block diagram of an apparatus for use in implementing the steps of the methods described herein;

FIG. 3 shows a rear view of an apparatus for use in implementing the steps of the methods described herein;

FIG. 4 shows a front view of an apparatus for use in implementing the steps of the methods described herein;

FIG. 5 shows a flow chart of the steps of a method described herein; and

FIG. 6 shows a mobile device running an application for controlling an apparatus implementing the steps of the methods described herein.

Throughout the description and the drawings, like reference numerals refer to like parts.

### DETAILED DESCRIPTION

The present disclosure relates to a method and apparatus for intelligently selecting music to be played in a room using context information which helps to provide a context of the environment in which the music is to be played such as characteristics associated with the room, as well as preference information for each of the users present in the room. The context information is indicative of characteristics of the room, such as the ambient sound level or the number of people in the room, and is received from one or more sensors. However, as will be discussed in detail later, the context information can include various other factors. The preference information includes information regarding the user's musical preferences, such as genres, artists, albums and songs they like or dislike.

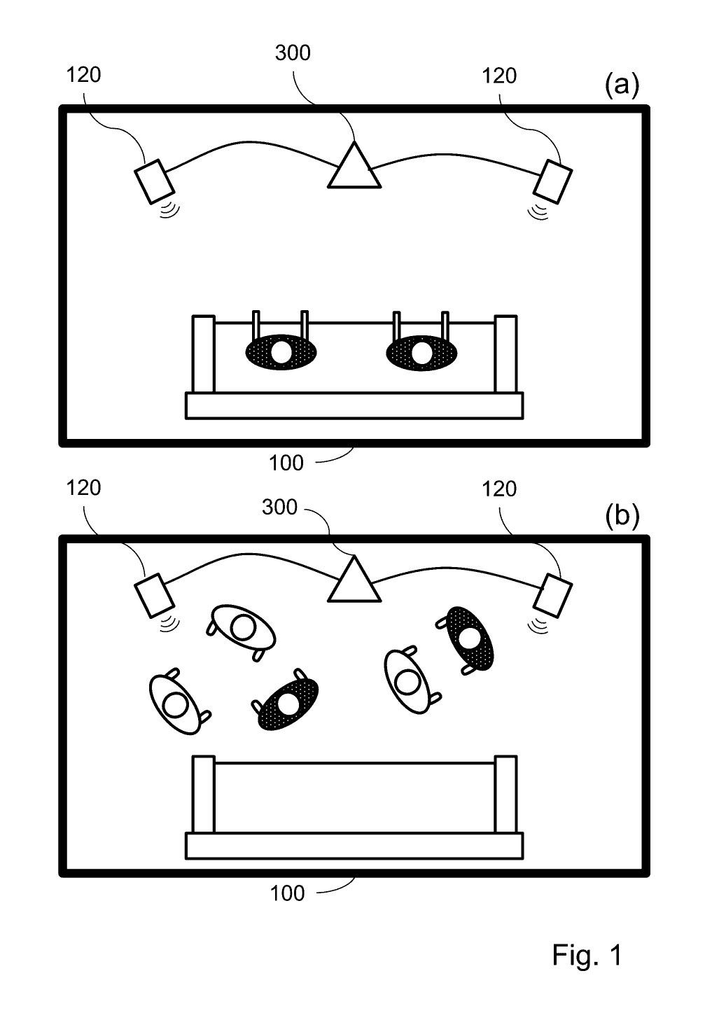

In order to better understand the methods described herein, two exemplary application scenarios are now described with reference to FIGS. 1(a) and 1(b), which show a diagram of an exemplary room 100 in which these methods can be used.

In both examples, the room 100 contains an apparatus, the Prizm® device 300, for use in implementing the steps of the methods described herein. The Prizm® device 300 is connected to a pair of speakers 120.

In FIG. 1(a), two users are present in the room 100, and are having a relaxing evening. The Prizm® device 300 determines context information (that it is the evening, that it is quiet and that two users are present in the room 100), identifies the two users, and determines preference information for each of the two users (they both like jazz in the evening). Based on the context and preference information, the Prizm® device 300 then generates a playlist of jazz music.

In FIG. 1(b), a party is taking place, and five users (two known users and three guests) are present in the room 100. The Prizm® device 300 determines context information (that it is the evening, that there is a large amount of noise in the room 100, and that five users are present in the room 100), identifies the known users, and determines preference information for each of the known users. Based on the context and preference information, the Prizm® device 300 then generates a playlist of dance music.

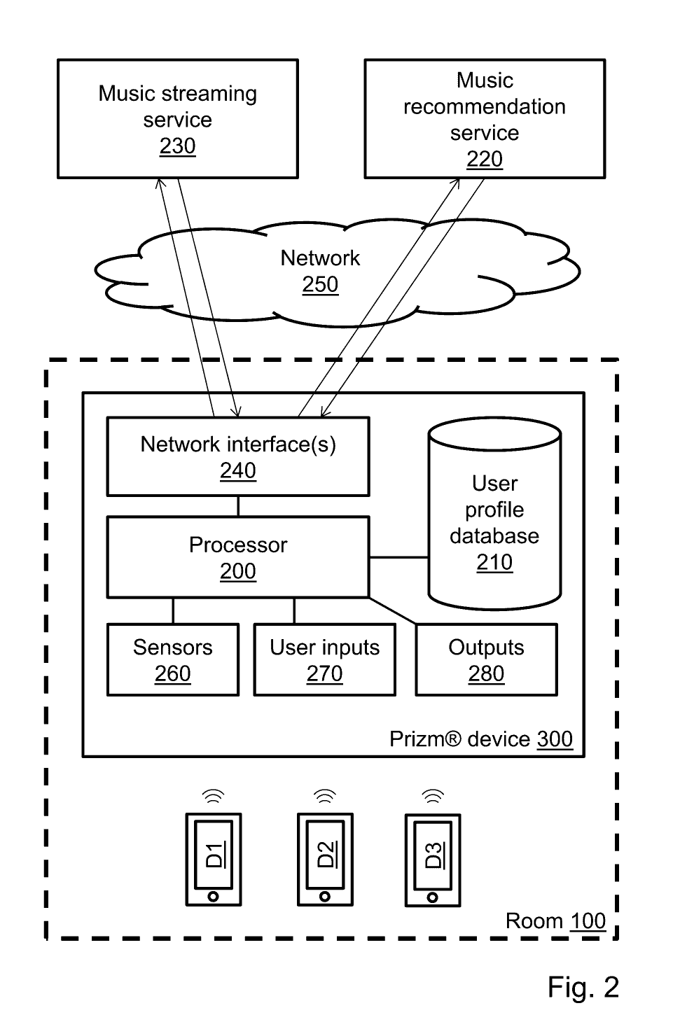

The components of the Prizm® device 300 which allow the Prizm® device 300 to intelligently select and play music, and the services with which the Prizm® device interacts, are illustrated in FIG. 2.

The Prizm® device 300 includes a processor 200 which is arranged to execute computer-readable instructions for implementing the steps of the methods described herein. The processor outputs the result of these instructions, for example, the music being played, via outputs 280. It will therefore be appreciated that any device with suitable hardware capabilities will be able to perform the functionality of the Prizm® device 300 and the invention defined herein is not limited specifically to the Prizm® device 300.

The processor 200 receives data from one or more sensors 260 for sensing characteristics of the playback environment, which in turn affects the music to be played. The sensors may include a motion sensor for sensing a movement in the playback environment, a temperature sensor for sensing a temperature in the playback environment, a microphone for sensing a sound level in the playback environment, and/or a photodetector for sensing a light level in the playback environment. Other sensors may be present in alternative arrangements.

The processor 200 may also receive commands and feedback from user inputs 270, such as a play/pause button, a skip button, a like button, and/or a dislike button. User(s) of the Prizm® device 300 can thereby control playback of music. Users can also change their preference information and influence the future selection of music.

The processor 200 may further receive instructions and/or data via one or more network interfaces 240, such as a WiFi interface or a Bluetooth interface. The processor 200 is able to output audio via a Bluetooth interface using the Advanced Audio Distribution Profile (A2DP).

The processor 200 identifies users present in the room 100 by detecting electronic devices D1, D2, D3 corresponding to the users. The electronic devices D1, D2, D3 are detected by the network interface(s) 240 based on the radiofrequency signals the electronic devices D1, D2, D3 emit; the network interface(s) 240 can therefore also be considered as sensors.

The processor 200 identifies music to be played by obtaining preference information for the user(s) present in the room 100 from a user profile database 210. The user profile database 210 contains a profile for each user. A profile will include the entire music library of the user as well as other information associated with the user. For example, this may include more general information identifying genres or artists that the user likes. The processor 200 combines the preference information with context information to obtain seed data (such as a song, album, artist or genre), and obtains a playlist by sending the seed data to a music recommendation service 220 via a network 250. The Prizm® device 300 then streams the tracks forming part of the playlist from a music streaming service 230.

Having described the components which allow the Prizm® device 300 to intelligently select and play music, an exemplary Prizm® device 300 is now described.

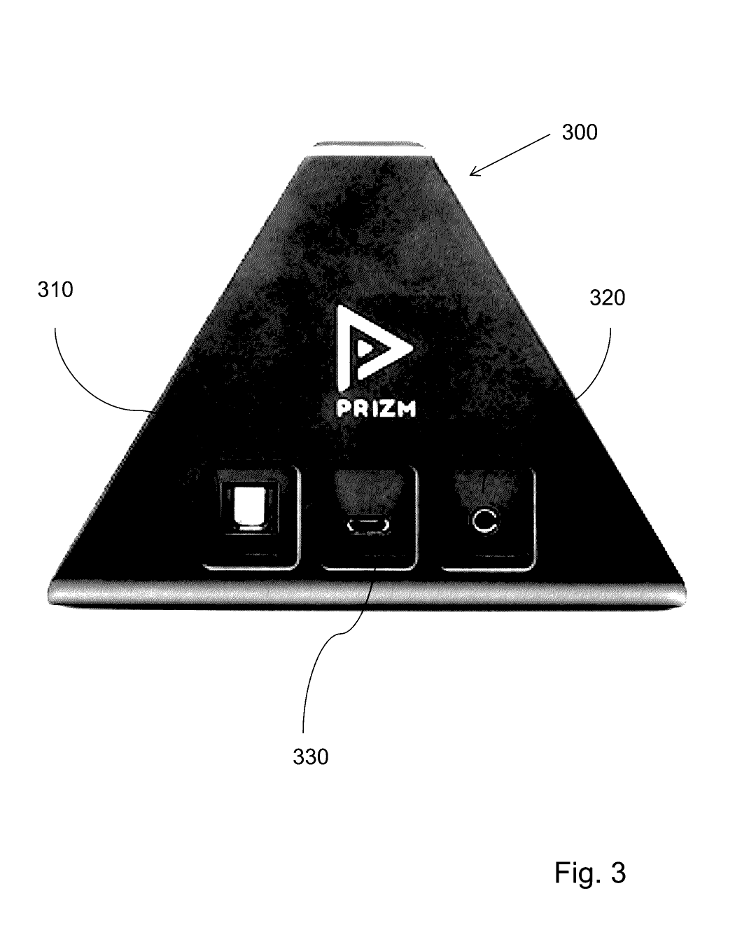

FIG. 3 shows a rear view of an exemplary Prizm® device. The Prizm® device 300 has an analogue 3.5 mm stereo output jack 320, a digital optical SPDIF/TosLink output port 310, and a micro-USB port 330 for providing power to the Prizm® device 300. The output ports enable the Prizm® device 300 to be connected to an amplifier or directly to a set of amplified speakers.

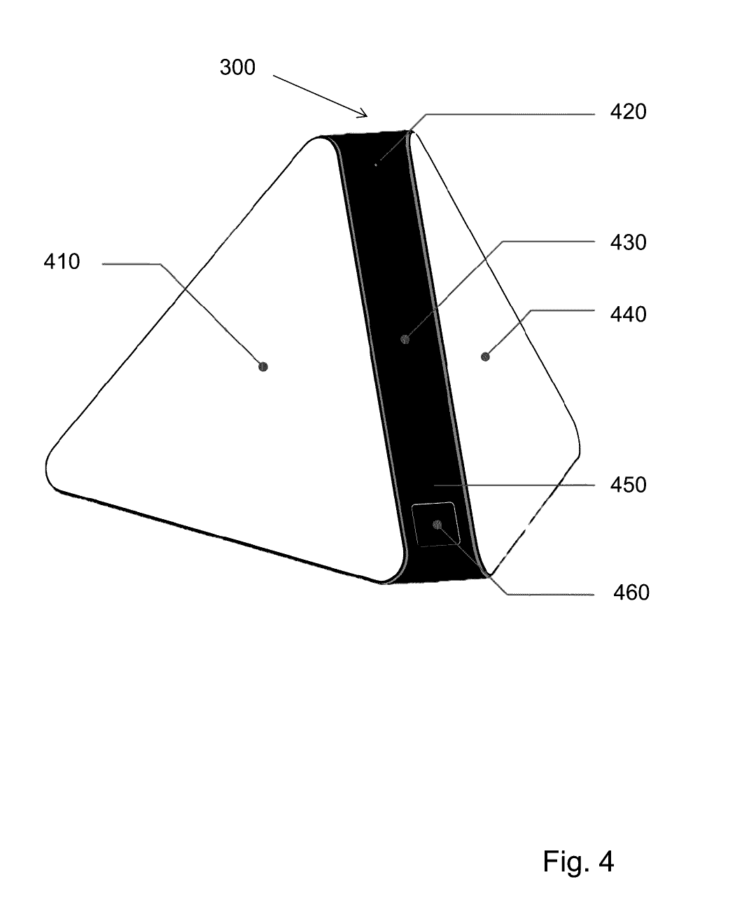

FIG. 4 shows a front view of an exemplary Prizm® device. The Prizm® device 300 can be controlled directly via physical controls on the device, without the use of a remote control device or application.

In particular, the Prizm® device 300 has a like button 410, a skip button 440, and a play/pause button 460. The Prizm® device 300 can start playing music as soon as the play/pause button 460 is pressed, or even as soon as a user is identified/detected in the room.

If pressed for a short amount of time, the like button 410 enables the user to indicate that they like the song currently being played. If pressed for a longer amount of time, the like button 410 enables a user to explore songs by the same artist. If pressed for a short amount of time, the skip button 440 enables the user to indicate that they wish to skip the song currently being played. If pressed for a longer amount of time, the skip button 440 enables a user to indicate that the song currently being played should never be played again.

The Prizm® device 300 also has an LED status indicator 420, a volume slider 430, and a microphone 450 for sensing a sound level in the room 100.

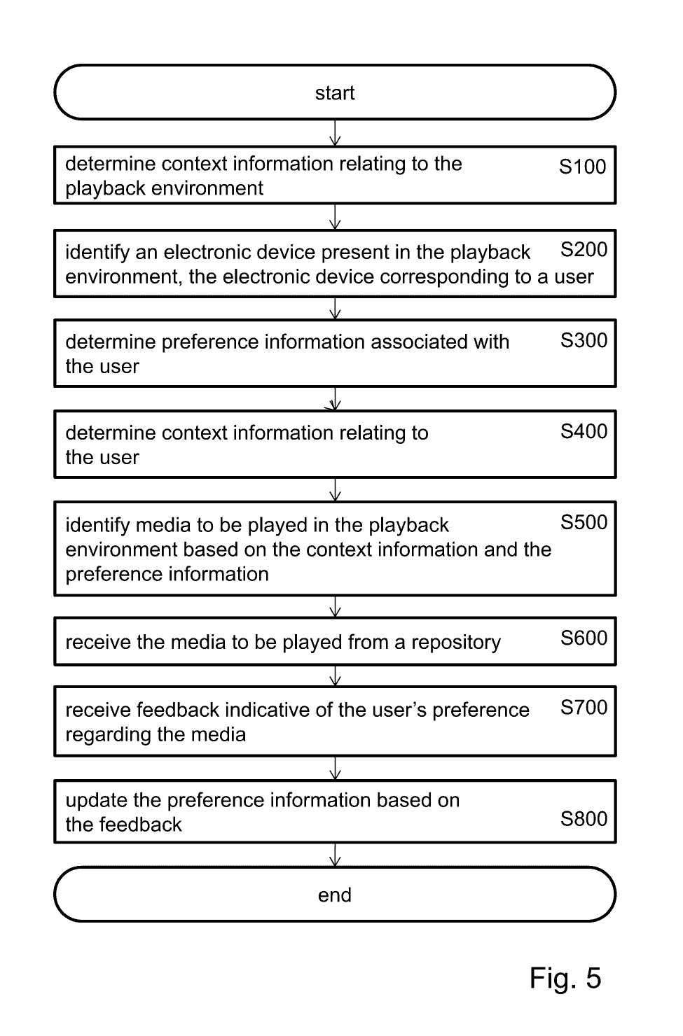

Having described an apparatus for implementing the methods described herein, a method for identifying media to be played in a playback environment is illustrated in FIG. 5. The playback environment is a room where one or more users wish to listen to music.

In a first step S100, context information relating to the playback environment is determined. The context information is received from one or more sensors which sense characteristics of the playback environment. Characteristics of the environment which can be sensed include:
a number of people present in the playback environment, which may be determined by determining a number of electronic devices present in the playback environment, even though it will be appreciated that other methods could be used,
a temperature in the playback environment,
a movement in the playback environment,
a sound level in the playback environment, or
a light level in the playback environment.

These characteristics may influence the music that is identified to be played in a variety of ways. For example, if a large number of people are present in the playback environment and there is a lot of ambient noise in the playback environment, a party may be taking place in the playback environment and dance music may be played.

In step S200, one or more electronic devices present in the playback environment are identified corresponding to different users. Users can be identified via their associated electronic devices as follows.

Electronic devices such as smartphones and wearables emit radiofrequency signals. In particular, electronic devices with WiFi or Bluetooth interfaces periodically broadcast discovery packets containing their unique Media Access Control (MAC) address. These packets are received and analysed, and by retrieving previously stored correspondences between users and the MAC address(es) of the electronic devices they use, the user(s) present in the playback environment can be identified. Broadcast packets with low power, as measured for example using a Received Signal Strength Indicator (RSSI), may be ignored since they are unlikely to correspond to electronic devices in the playback environment and are instead likely to correspond to electronic devices in neighbouring homes. Broadcast packets with low power may also be ignored when determining the number of electronic devices present in the playback environment (in step S100). The presence of unknown MAC addresses can also affect the context which is detected in S100.

In step S300, preference information associated with the identified user(s) is determined. The preference information associated with each user is obtained from a user profile stored in a user profile database 210.

The preference information is associated with a context, to reflect the fact that some users may only like to listen to specific songs, albums, artists or genres in specific contexts.

If more than one user has been identified, the preference information for each of the identified users is combined. The combined preference information is obtained by finding intersections between the user profiles for each of the identified users. The intersections may include tracks, artists or albums that all of the identified users have liked, where an artist/album is considered to have been liked by a user if at least one song by that artist/song on that album has been liked. If no intersections are found, the musical characteristics of the songs which have been liked by each of the identified users can be analysed in order to find genres which are likely to appeal to all the identified users. In other words, overlap between the musical taste of identified users is established.

The user profile also includes the MAC address(es) for the user's electronic device(s). For example, a first user's profile may be associated with their phone, and a second user's profile may be associated with their phone and their Fitbit® electronic wristband.

In optional step S400, context information relating to the user(s) is determined. For example, the context information relating to the user(s) may be biometric data, and the music that is played can then be selected based on the user's current or recent physical activity (using heart rate or accelerometer data), or based on the user's current mood (based on electroencephalogram data).

In step S500, media to be played in the playback environment is identified based on the context information relating to the playback environment and the preference information associated with the user(s), and optionally also based on the context information relating to the user(s).

More specifically, seed data associated with the media is determined by combining the context information and the preference information. The seed data may, for example, be one or more musical genres, one or more tracks, one or more artists, one or more albums, one or more musical characteristics, etc.

The seed data is then sent to the music recommendation service/engine 220, which analyses the seed data and returns a list of tracks to be played, in the form of a list of track identifiers.

In step S600, a request for the tracks to be played is sent to a repository. The repository is operated by a music streaming service 230 such as Spotify®, Deezer®, SoundCloud®, Rhapsody®, last.fm®, or rdio®. The tracks are then received from the music streaming service 230.

In optional step S700, feedback indicative of the user(s)'s preference regarding the media is received. The feedback may be explicit or implicit, and explicit feedback is generally given more weight than implicit feedback. However, it will be appreciated that a suitable weighting for different types of feedback could be developed for different systems.

Types of feedback that may be received from a user include:
1. the user skipping a song (implicit negative feedback);
2. the user playing at least a predetermined portion (e.g., 90%) of a song without skipping (implicit positive feedback);
3. the user liking a song (explicit positive feedback);
4. the user disliking a song or indicating that the song should never be played again (explicit negative feedback); or
5. the user disliking a song in more than one context (explicit negative feedback).

Feedback may be received from the user(s) using buttons 270 on the Prizm® device 300, and/or the feedback may be received via a smartphone application which communicates with the Prizm® device 300.

In optional step S800, the preference information is updated based on the feedback received. Specifically, the profile associated with the user(s) is updated. This enables the Prizm® device 300 to ‘learn’ from interactions with the user(s).

The methods described herein select music that is likely to appeal to the user(s) at a particular time, and may thereby advantageously reduce the number of skipped songs and reduce the amount of unnecessary network traffic in the case where the songs are received from a music streaming service.

In step S200, identifying an electronic device present in the playback environment by detecting radiofrequency signals emitted by the electronic device may advantageously eliminate the need for the electronic device to be specially configured to be compatible with the Prizm® device 300 (e.g. using a companion smartphone application).

In step S500, sending seed data to the music recommendation service/engine 220 instead of sending all the preference and context information may advantageously reduce the amount of network traffic.

Storing preference information onboard the Prizm® device 300 instead of storing it on a remote server may advantageously increase the privacy of the user(s) of the Prizm® device 300 and reduce the likelihood of the preference information being compromised.

In step S600, receiving the media to be played from a music streaming service may advantageously reduce the amount of data storage required on the Prizm® device 300.

Updating the preference information based on the feedback from the user in step S800 may advantageously reduce the number of skipped songs, thereby reducing the amount of unnecessary network traffic in the case where the songs are received from a music streaming service.

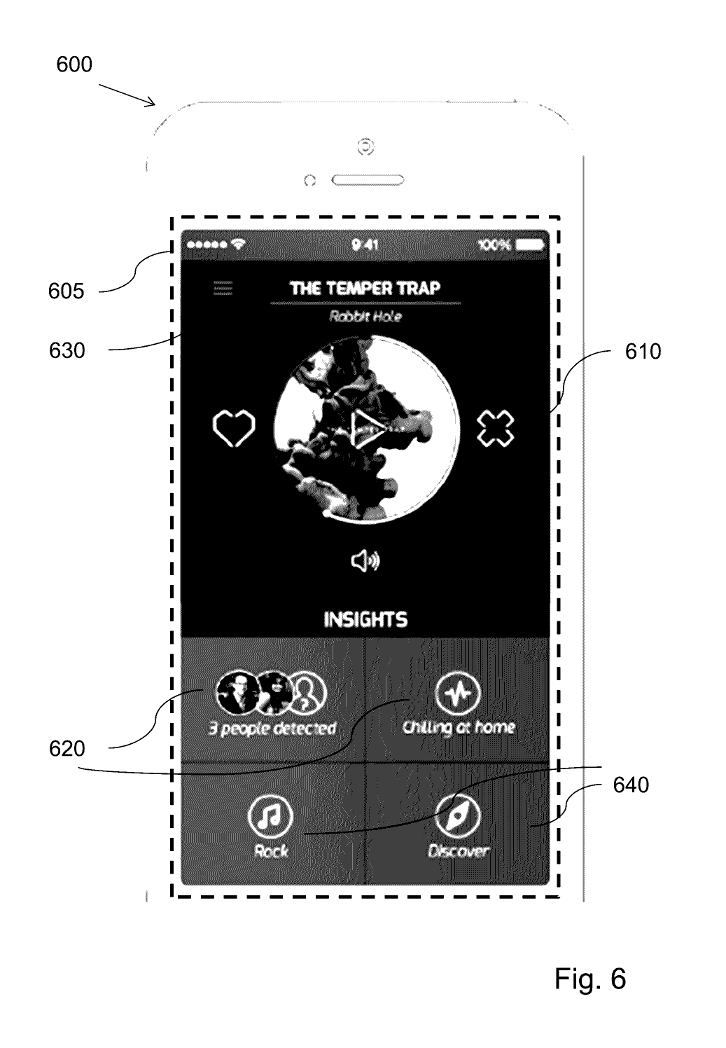

It will be appreciated by a person of ordinary skill in the art that the ordering of the steps in FIG. 6 is merely exemplary. For example, step S200 and/or step S300 could be performed before step S100. Some of the steps in FIG. 6 could also be performed in parallel. The steps of FIG. 6 may be continuously repeated in order to adapt to changes in the playback environment, such as a new user entering the playback environment or a user leaving the playback environment.

Usage data and user profiles may be saved to a remote server. In this way, when in the home of a friend, a user can download their user profile from the remote server for use with the friend's Prizm® device.

FIG. 6 shows a mobile device 600 running an application 605 for controlling the Prizm® device 300. The application 605 runs on the iOS and Android platforms, and allows users to adjust/correct the automatic choices made by the Prizm® device 300. The application 605 also allows users to browse existing playlists, search for a specific track or start music with a specific genre.

The application 605 includes an area 630 for selecting a specific song, playlist or genre to be played in the playback environment. The application 605 further includes playback controls 610: a like button, a skip button, a play/pause button, and a volume slider. The application 605 displays the context which has been detected in area 620. The application 605 also displays the music parameters which have been chosen by the Prizm® device 300 in area 640. Interactions with the Prizm® device 300 (via buttons on the Prizm® device 300 or via the mobile device application) and playback history are saved in order to improve the selection of music.

Although a detailed example of at least one aspect of the present invention is described above, certain modifications to the above example would be obvious to a person of ordinary skill in the art. As such, the scope of the invention is limited only by the accompanying claims.

For example, although in the present disclosure the media to be played is music, it will be appreciated by a person of ordinary skill in the art that the methods described herein could also be applied to other forms of media. For example the media could be video (including, in particular, music videos).

The sensor(s) 260 from which the context information is received may be directly connected to the Prizm® device 300. Alternatively, the Prizm® device 300 may communicate with remote sensor(s) present in the room, home or building via a Local Area Network (LAN).

While it has been described that the user is identified by means of an electronic device associated with the user, and the number of people in the environment is determined based on the number of electronic devices in the environment, it will be appreciated that users/people may be identified in different ways. For example, bio metric information could be used to identify users. For example, voice recognition could be used to identify someone. Alternatively, retina scanning, fingerprint scanning or some other form of biometric identification could be used to identify people entering and leaving a room.

In addition to, or instead of, receiving context information from one or more sensors 260, context information may include a current date, a current time, and/or a current weather condition. For example, a user may wish to listen to energetic music on weekday mornings, or music with lyrics containing the word ‘sun’ when the sun is shining.

The user profiles described above may be stored onboard the Prizm® device 300, in the user profile database 210, and/or on a remote server.

Instead of being operated by a music streaming service, the repository may contain only the user(s)'s own music collection, stored either onboard the Prizm® device 300, or on a remote server.

It will be appreciated that the recommendation engine may be hosted by the manufacturer of the device or by any third party.

In addition to being used to update the preference information, the feedback may be sent to the repository; for example, songs which have been liked may be added to a playlist stored on a music streaming service's servers.

In some arrangements, only a subset of the electronic devices identified in the playback environment may have associated preference information. In this case, the other electronic devices would not have a corresponding user profile, and would be considered as unknown guests. However, the presence of unknown guests may be used as context information to influence the selection of music to be played.

The approaches described herein may be embodied on a computer-readable medium, which may be a non-transitory computer-readable medium. The computer-readable medium carrying computer-readable instructions arranged for execution upon a processor so as to make the processor carry out any or all of the methods described herein.

The term “computer-readable medium” as used herein refers to any medium that stores data and/or instructions for causing a processor to operate in a specific manner. Such storage medium may comprise non-volatile media and/or volatile media. Non-volatile media may include, for example, optical or magnetic disks. Volatile media may include dynamic memory. Exemplary forms of storage medium include, a floppy disk, a flexible disk, a hard disk, a solid state drive, a magnetic tape, or any other magnetic data storage medium, a CD-ROM, any other optical data storage medium, any physical medium with one or more patterns of holes, a RAM, a PROM, an EPROM, a FLASH-EPROM, NVRAM, and any other memory chip or cartridge.

1. A method for identifying media to be played in a playback environment, the method comprising:
determining context information relating to the playback environment;
identifying a user in the playback environment;
determining preference information associated with the user; and
identifying media to be played in the playback environment based on the context information and the preference information.

2. The method of claim 1, wherein the playback environment comprises a room.

3. The method of claim 1, wherein determining the context information comprises receiving the context information from a sensor operable to sense a characteristic of the playback environment.

4. The method of claim 1, wherein determining the context information comprises receiving the context information from a sensor operable to sense one of:
a number of people present in the playback environment,
a temperature in the playback environment,
a movement in the playback environment,
a sound level in the playback environment, and
a light level in the playback environment.

5. The method of claim 1, wherein determining the context information comprises determining at least one of:
a current date,
a current time, and
a current weather condition.

6. The method of claim 1 further comprising determining context information relating to the user, and wherein identifying media to be played in the playback environment comprises identifying media to be played in the playback environment based on the context information relating to the playback environment, the context information relating to the user, and the preference information.

7. The method of claim 1 further comprising determining context information relating to the user based on biometric data, and wherein identifying media to be played in the playback environment comprises identifying media to be played in the playback environment based on the context information relating to the playback environment, the context information relating to the user, and the preference information.

8. The method of claim 1, wherein identifying a user in the playback environment comprises detecting radiofrequency signals emitted by an electronic device associated with the user and identifying the user based on the radiofrequency signals.

9. The method of claim 1, wherein identifying a user in the playback environment comprises detecting radiofrequency signals emitted by an electronic device associated with the user, determining that the electronic device is present in the playback environment based on a strength of the radiofrequency signals, and identifying the user based on the radiofrequency signals.

10. The method of claim 1, wherein identifying a user in the playback environment comprises detecting biometric data associated with the user.

11. The method of claim 1, wherein determining preference information associated with the user comprises obtaining preference information from a profile associated with the user.

12. The method of claim 1 further comprising:
receiving feedback indicative of the user's preference regarding the media; and
updating the preference information based on the feedback.

13. The method of claim 1, wherein identifying media to be played in the playback environment based on the context information and the preference information comprises:
determining seed data associated with the media to be played by combining the context information and the preference information; and
receiving the media to be played based on the seed data.

14. The method of claim 1 further comprising receiving the media to be played from a repository.

15. The method of claim 1 further comprising:
receiving the media to be played from a repository;
receiving feedback indicative of the user's preference regarding the media; and
sending the feedback to the repository.

16. The method of claim 1, wherein:
the user in the playback environment is a first user,
identifying device user present in the playback environment comprises identifying the first user and identifying a second user present in the playback environment, and
determining preference information comprises combining preference information associated with the first and second users.

17. An apparatus suitable for playing media in a playback environment, the apparatus comprising a processor configured to execute the method of claim 1.

18. The apparatus of claim 17 further comprising a sensor operable to sense a characteristic of the playback environment, and wherein determining the context information comprises receiving the context information from the sensor.

19. The apparatus of claim 17 further comprising one or more sensors, wherein each of the one or more sensors is one of:
a communications interface operable to sense a number of people present in the playback environment;
a motion sensor operable to sense a movement in the playback environment;
a temperature sensor operable to sense a temperature in the playback environment;
a microphone operable to sense a sound level in the playback environment; and
a photodetector operable to sense a light level in the playback environment,
and wherein determining the context information comprises receiving the context information from the one or more sensors.

20. The apparatus of claim 17, further comprising a communications interface and an output interface, and wherein the processor is further configured to receive the media via the communications interface and play the media via the output interface.

21. A non-transitory computer-readable medium carrying computer-readable instructions arranged, upon execution by a processor, to cause the processor to carry out the method of claim 1.
